(19) United States
(12) Patent Application Publication
(10) Pub. No.: US 2022/0230098 A1
(43) Pub. Date: Jul. 21, 2022

(54) Prediction of Toner Replacements with Logistic Regression

(71) Applicant: KYOCERA Document Solutions, Inc., Osaka (JP)

(72) Inventor: Oleg Y. Zakharov, Walnut Creek, CA (US)

(73) Assignee: KYOCERA Document Solutions, Inc., Osaka (JP)

(21) Appl. No.: 17/152,109

(22) Filed: Jan. 19, 2021

(51) Int. Cl. G06N 20/20; G06N 5/02

(52) U.S. Cl. CPC G06N 20/20; G06N 5/02

(57) ABSTRACT

A method of predicting of toner replacements with logistic regression involves collecting toner level data for a print cartridge in a printing device, during a current replacement cycle of the print cartridge, at toner level data intervals, the toner level data comprising a volume percentage of toner in the print cartridge as time series level data points. The print volume data of the printing device is collected, during the current replacement cycle of the print cartridge, at a print volume data interval, the print volume data comprising a number of pages printed during the print volume data interval as time series volume data points. The toner level data and the print volume data are applied as input variables to a predetermined regression learning process. A replacement process for the print cartridge is triggered on condition that the predicted number of analytical intervals satisfies a threshold.

### BACKGROUND

In order to properly maintain image forming devices such as printers, copiers, facsimile, and multi-function peripherals, many of these devices are equipped with the capability to record different operating variables, such as the number of pages printed, the amount of toner used, the amount of toner remaining, etc.

The image forming device should be available for normal operations, such as printing, scanning, copying and other functions, with only a minimum number of interruptions. An example of an interruption is running out of toner in a toner cartridge.

Determining the toner level of a toner cartridge is useful information for determining when a toner cartridge will need to be replaced. However, accurately determining toner levels in a printing device can be a difficult task that may be due to several factors. One of the sources of the issue may be due in part to the limitations of the sensors associated with the toner cartridges. Often, these sensors provide inaccurate toner level data especially when the toner levels within the print cartridge are low. In some instances, the toner level, reported by the printing device, may indicate the same toner level even after the printing device completes certain print volume. If a user relies solely on the sensor data from the printing device, the toner may run out before a new replacement toner cartridge is available. Alternatively, the user may order a new toner cartridge well before it is necessary to do so. Therefore, a need exists for more accurately predicting when a toner cartridge replacement may be necessary.

### BRIEF SUMMARY

A method of predicting of toner replacements with logistic regression involves collecting toner level data for a print cartridge in a printing device, during a current replacement cycle of the print cartridge, at toner level data intervals, the toner level data comprising a volume percentage of toner in the print cartridge as time series level data points. In the method print volume data of the printing device is collected, during the current replacement cycle of the print cartridge, at a print volume data interval, the print volume data comprising a number of pages printed during the print volume data interval as time series volume data points. In the method, the toner level data and the print volume data are applied as input variables to a predetermined regression learning process. In the method, a replacement process for the print cartridge is triggered on condition that the predicted number of analytical intervals satisfies a threshold. In the method, the predetermined regression learning process includes a regression model and determines a number of predicted days until the print cartridge requires replacement. In the method, the predetermined regression learning process outputs a predicted number of analytical intervals until the print cartridge needs to be replaced. In the method, the predicted number of analytical intervals is the number of predicted days until the print cartridge requires replacement divided by an analytical interval. In the method, the analytical interval is a discrete interval of time during a life cycle of the print cartridge.

A system for predicting of toner replacements with logistic regression includes a printing device, a print server, a processor, and memory. The memory stores instructions that, when executed by the processor, configure the system to perform the features in the method described above.

A printing device includes a processor and memory storing instructions that, when executed by the processor, configure the printing device to perform the features in the method described above.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 in accordance with one embodiment.

FIG. 2 illustrates an image forming apparatus 200 in accordance with one embodiment.

FIG. 3 illustrates a graph 300 in accordance with one embodiment.

FIG. 4 illustrates a graph 400 in accordance with one embodiment.

FIG. 5 illustrates a method 500 in accordance with one embodiment.

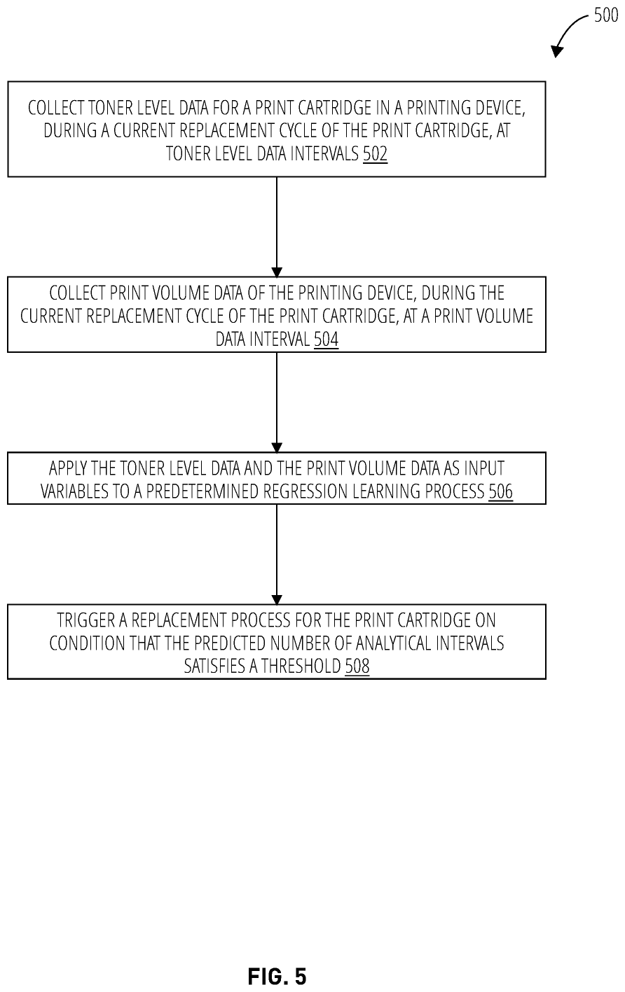

FIG. 6 illustrates a method 600 accordance with one embodiment.

FIG. 7 illustrates a method 700 with one embodiment.

FIG. 8 illustrates a graph 800 showing a best fit line.

FIG. 9 displays a set of graphs as examples of different learning rates.

FIG. 10 illustrates a decision tree 1000 in accordance with one embodiment.

FIG. 11A illustrates a process for building a random forest in accordance with one embodiment.

FIG. 11B illustrates a process for building a random forest in accordance with one embodiment.

FIG. 12 depicts an illustrative system architecture and data processing device 1200 that may be used in accordance with one or more illustrative aspects described herein.

### DETAILED DESCRIPTION

A system and method of predicting of toner replacements with logistic regression is provided to improve accuracy of the toner level measurement. The system and method may take print volume data and runs a regression function that forecasts a date of replacement for the toner. With these forecasts, a user may be able order replacement toner cartridges at the required replacement intervals such that neither a deficient nor excess stock of replacement toner cartridges is present in local storage.

In the system and method, a regression function may be utilized to map toner level data (input data) from a printing device to known replacement intervals of the toner cartridge (print cartridge) on that device. These print cartridge replacement intervals may then be predicted and provided as the output of the regression model.

In the regression model the input is viewed as the independent variables and is the set of periodically measurable toner levels, presented as time series data points. The exact measurement of toner levels is not necessary because these levels will be measured by time intervals. The output, which is the dependent variable, is a reasonably short set of time intervals of toner (cartridge) replacements.

Toner level data is measurable in percent (100%-0%) of remaining a toner powder (or ink) in the print cartridge. These measurements may be observed on a daily basis. Each of the printing devices may report its toner level data to a centralized system, such as central server and database.

### Input-Independent Variables

To train and run the predictive model, several toner level data points are utilized. These data points are measured periodically after each toner unit replacement. The system monitors and records the time interval for the toner to drop from the level of 99% to the level of 50%. Table 1 illustrates an example of the number of days it takes devices to reach different toner levels.

TABLE 1

| Device | Days from | Days from | Days from |
|---|---|---|---|
| ID | 99% to 75% | 75% to 50% | 50% to 30% |
| 0001 | 30 | 35 | 15 |
| 9990 | 28 | 22 | 10 |

### Output-Dependent Variables

In order to train a regression model, a round number of days between toner cartridge replacements may be grouped under a certain time interval, such as weeks. For example, instead of tracking the replacement time in days, the tracking interval for replacement may be set to weeks. Table 2 illustrates an exemplary replacement interval for toner cartridges in terms of weeks.

TABLE 2

| | | Date Intervals |
|---|---|---|
| | | of Toner |
| | | Replacement |
| Device ID | Replacement | (Weeks) |
| 0001 | Jan. 12, 2019 | 8 |
| 9990 | Mar. 25, 2019 | 16 |

### Toner Level Observations and Anomalies

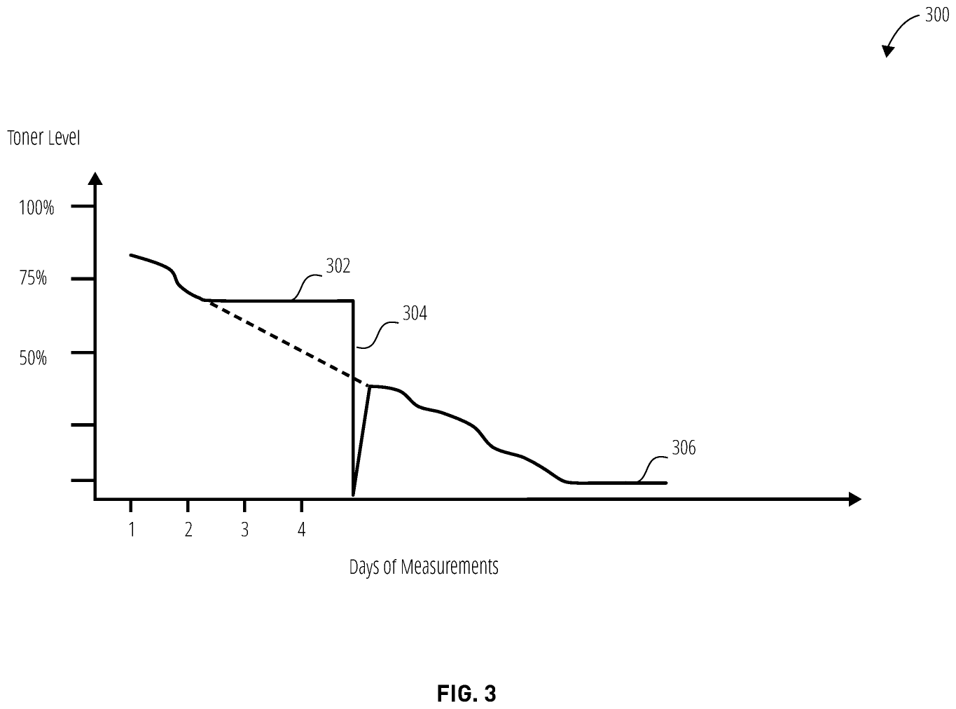

A print cartridge may sometimes report an inaccurate toner level for the print cartridge. For example, in FIG. 3 a toner level graph 300 is shown plotting the toner level versus days of measurements. In the graph 300, an anomaly may be seen where a sensor reports a constant level of toner (toner level data 302), even though print volume is increasing. Another example of an anomaly is a sudden drop of reported level, which can be caused by a defective contact between a cartridge's sensor and a data collector (toner level data 304). The reported toner level can also jump up after rebooting the printing device or after shaking the cartridge. In some instances when the toner level becomes low, the sensor may report a continuous value for the toner level (toner level data 306). In this case, the toner level may not go below zero and may continuously report a ‘low level’ as 5%, which may be difficult to interpret accurately.

In order to account for the anomalies and the reporting issue, the toner level data is processed for use in the regression model. To process the data, at least three data points of the toner level are taken after the most recent cartridge replacement and along with several data points of the print volume.

### Data Preparation for Regression Analysis

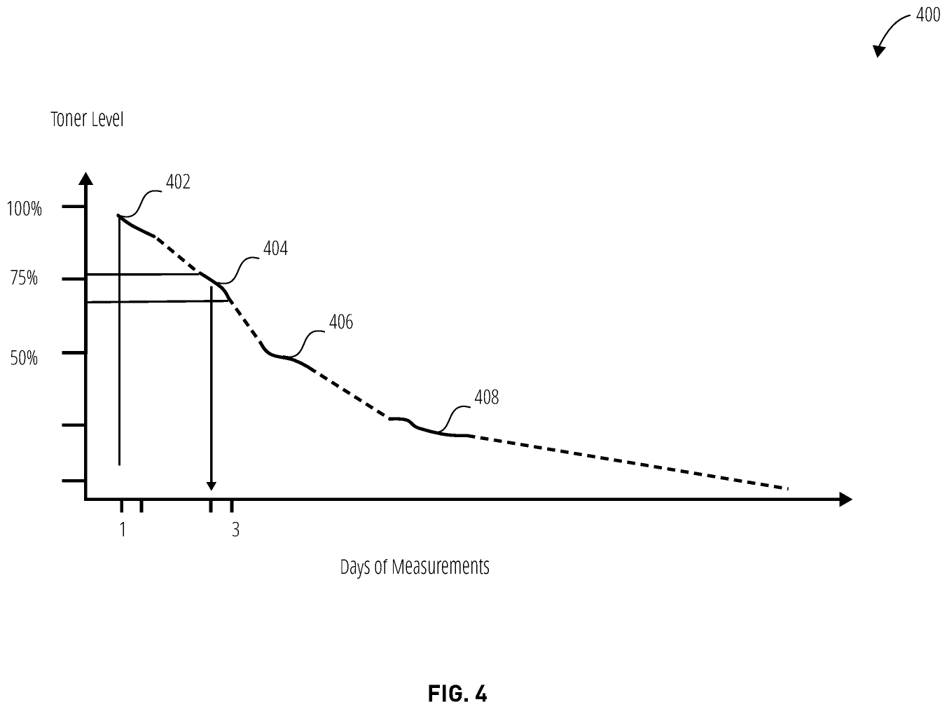

FIG. 4 illustrates a graph 400 showing an exemplary embodiment where toner level intervals were utilized to represent the changes in data points. In the graph 400, the data point 402 represents the periodical toner replacement date, when toner level had increased to at least 80%. In the graph 400, the data point 404 represents the date when the toner reached level of 75%-70%. The use of an interval for toner level data is provided due to a margin of error from the sampling, as the toner level data utilized in the regression model and actual toner level may vary. The margin of error for the sampling of the toner level may exist due to the inaccuracy of the measurements from the sensor data. Due to the sampling rate, it may be difficult to determine when the toner level is exactly at 75% on each printing device, since the toner level one day may report 76% and next day may report 73%. To account for these sample issues, the system monitors for a date when the toner level may be ‘approximately’ 75% (±2%). Additionally, the margin of error for the toner level may depend on the actual print volume produced by the printing device. Some printing devices may consume 5% of the toner cartridge in one day, and some printers consume only 1% of toner in a day.

Another data point collected is data point 406 that records the date when the level reaches 55%-50%. Similar to the previous data point, the date may be applied to a toner level of 53% or 52% with a reasonable margin, which depends on the actual print volume during a recent time interval. Still another data point collected is data point 408, which includes the date when the toner level reaches 35%-30%.

The data points mentioned above provide a snapshot of the toner level's depletion during the early stages of the replacement cycle. By providing these data points, the regression model may predict in how many bucketed aggregated intervals (e.g., weeks) the print cartridge may need to be replaced. Thus, in an embodiment, the regression model may take into account the at least three data points of the toner level, in how many days the print cartridge reaches those specific levels, and the print volume during the current replacement cycle.

### Regression Model Selection and Implementation

With pre-processed historical data bucketed (i.e., grouped) by the days between replacements and viewed as analytical intervals (i.e., discrete intervals), (where one interval may be 5 days long or 7 days long etc), the number of possible outputs becomes a discrete set of prediction outputs. This may be done for logistic regression predictions as they are discrete (only specific values or categories are allowed). For instance, if the expected output is between 4 and 20, where:

Output=days of replacement/duration of analytical interval

The possible outputs may also be narrowed down by filtering out devices with extremely high print volume, when expected replacement can be shorter than 2 analytical intervals.

An exemplary implementation of this process may utilize a regression model that is based on a decision tree algorithm, such as a Random Forest regression model. Such approach may provide better results, compared to a Linear Regression due to the fact that simple interpolation may not work well for multiple independent variables. However, a Random Forest regression model, or similar models, may provide better results with many hierarchical levels of tree nodes.

A method of predicting of toner replacements with logistic regression involves collecting toner level data for a print cartridge in a printing device, during a current replacement cycle of the print cartridge, at toner level data intervals, the toner level data comprising a volume percentage of toner in the print cartridge as time series level data points. In the method, print volume data of the printing device is collected, during the current replacement cycle of the print cartridge, at a print volume data interval, the print volume data comprising a number of pages printed during the print volume data interval as time series volume data points. In the method, the toner level data and the print volume data are applied as input variables to a predetermined regression learning process. In the method, a replacement process for the print cartridge is triggered on condition that the predicted number of analytical intervals satisfies a threshold. In the method, the predetermined regression learning process includes a regression model and determines a number of predicted days until the print cartridge requires replacement. In the method, the predetermined regression learning process outputs a predicted number of analytical intervals until the print cartridge needs to be replaced. In the method, the predicted number of analytical intervals is the number of predicted days until the print cartridge requires replacement divided by an analytical interval. In the method, the analytical interval is a discrete interval of time during a life cycle of the print cartridge.

In some configurations of the method, the regression model includes a decision tree algorithm. In this configuration, the regression model may be a Random Forest model.

In some configurations of the method, the threshold may be satisfied when the predicted number of analytical intervals equals two or less.

In some configurations of the method, the print cartridge may include multiple colors, the toner level data and the print volume data are collected for each color of the print cartridge, and the predetermined regression learning process applies the regression model to the toner level data and the print volume data on a color-by-color basis.

In some configurations, the method may further include training the predetermined regression learning process. The training may involve collecting toner level training data, print volume training data, and at least one print cartridge replacement interval, each over a training time interval. In the training the toner level training data may comprise the volume % of toner in the print cartridge as time series level data points. In the training, the print volume training data may comprise the number of pages printed during the print volume data interval as time series volume data points. In the training a discrete print cartridge replacement interval may be calculated by dividing the at least one print cartridge replacement interval by a training analytical interval, wherein the training analytical interval is a discrete training interval of time during at least one life cycle of the print cartridge. In the training, a training data set may be created including input features and targets. The training data set may include the toner level training data, the print volume training data, the discrete print cartridge replacement interval. In the training, the regression model may be trained using the training data set, wherein the discrete print cartridge replacement interval is at least one input feature as well as at least one target, thereby creating a trained regression model.

In some configurations, the training may further involve removing the discrete print cartridge replacement interval from the training data set, thereby forming a test data set. The test data set may be applied to the trained regression model, thereby producing a predicted discrete print cartridge replacement interval. The predicted discrete print cartridge replacement interval may be compared to the discrete print cartridge replacement interval, thereby determining an accuracy of the trained regression model.

In some configurations, the print volume data includes at least three data points during the print volume data interval.

In some configurations, the toner level data includes at least three data points during the toner level data interval.

In some configurations, the analytical interval is at least one week. In this configuration, the prior customer use for a particular customer may be utilized to determine the analytical interval for the print cartridges of the particular customer.

A system for predicting of toner replacements with logistic regression may include a printing device, a print server, a processor, and memory. The memory stores instructions that, when executed by the processor, configure the system to perform the features in the method described above.

A printing device utilized for predicting of toner replacements with logistic regression may include a processor and memory storing instructions that, when executed by the processor, configure the printing device to perform the features in the method described above.

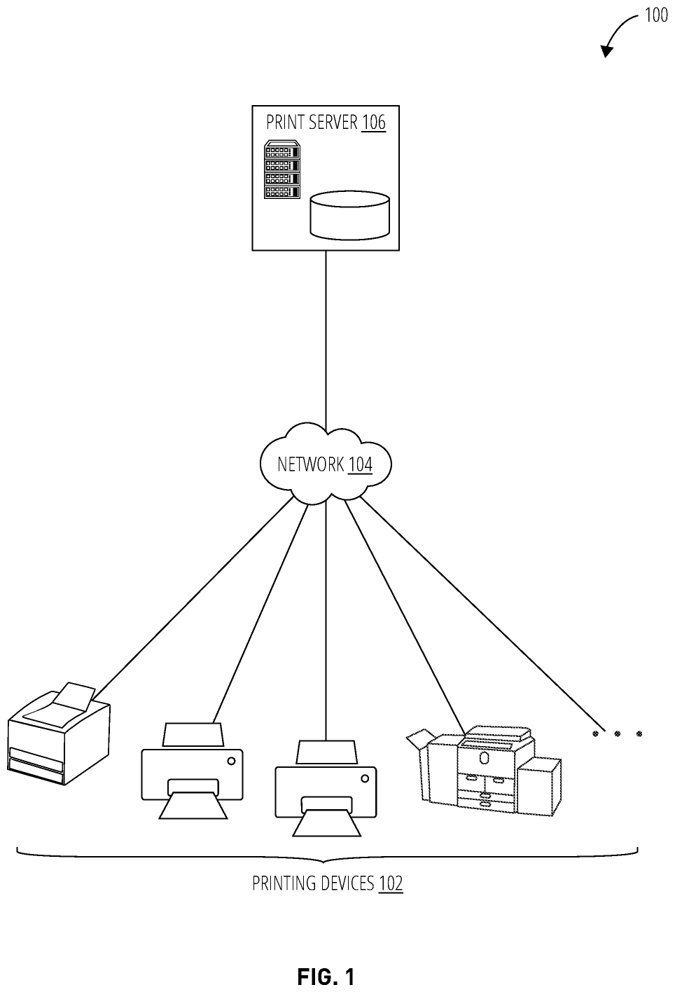

FIG. 1 is a block diagram illustrating an example system 100 according to an example embodiment of the present disclosure. System 100 may include one or more printing devices 102, and a print server 106 which may be connected via a network 104. In some examples, system 100 may include more or fewer printing devices 102 than are shown in FIG. 1, may include additional servers and/or computing devices, and/or may include one or more other systems or devices in addition to or instead of those shown in FIG. 1.

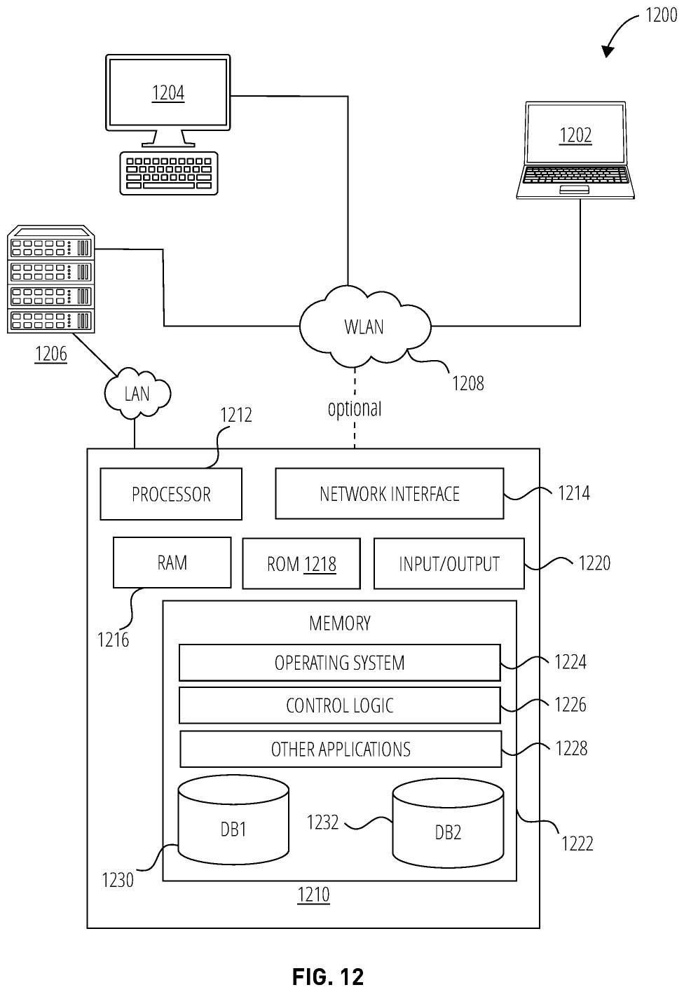

Printing devices 102 include one or more multi-function printing devices and/or stand-alone printing devices. A given printing device may be configured to perform one or more functions such as printing, scanning, emailing, storing, modifying, receiving, or transmitting one or more documents and/or files. In some examples, printing devices 102 may include one or more computing devices such as system architecture and data processing device 1200, or one or more components or aspects of system architecture and data processing device 1200 described in more detail with respect to FIG. 12. In some examples, one or more of the printing devices 102 may be connected to one or more personal computers, laptops, servers, handheld devices, and/or other computing devices and systems, which may be used in connection with the printing device to perform one or more actions, such as those described above.

Each printing device 102 may be configured to perform one or more steps, actions, or functions described herein. For example, a printing device may communicate with print server 106, to transmit and/or receive data or information via network 104 including time intervals, numbers of printed pages, numbers of errors, and other related information.

Print server 106 may include a cloud based server, for example, that can perform one or more tasks to manage and/or maintain printing devices 102. Print server 106 may communicate with printing devices 102 to transmit or receive data. For instance, in some examples print server 106 may transmit a command to the one or more printing devices 102 to reset, install updates, or perform one or more printing or maintenance functions or operations. In other examples, print server 106 may receive data from the one or more printing devices 102, such as a page count (i.e., number of pages printed), an error count, one or more error messages, or data corresponding to a page count, error count, and/or error message.

In some examples, print server 106 may be configured to perform one or more functions or steps of the example methods and systems disclosed herein. For instance, print server 106 may determine a time interval, number of pages printed, and number of printing-device errors for one or more printing devices. Print server 106 may also determine a ratio of printed pages per printing-device error for one or more printing devices over a given time interval. Further, print server 106 may determine one or more Markov chain coefficients based on the time interval, number of pages printed, number of printing-device errors, and/or determined ratio. Print server 106 may then determine an operational status of one or more printing devices and take one or more actions based on the determined operational status.

Print server 106 may include one or more computing devices or systems (not shown), and may be consolidated in a single physical location, or distributed across two or more physical locations. Print server 106 may include hardware, software, and/or firmware configured to carry out one or more functions or acts described herein.

Network 104 in the system 100 may include one or more wired or wireless connections that support communication between the devices of system 100. In some examples, network 104 may support one or more communication protocols, such as Extensible Messaging and Presence Protocol (XMPP), File Transfer Protocol (FTP), HyperText Transport Protocol (HTTP), Java Message Service (JMS), Simple Object Access Protocol (SOAP), Short Message Service (SMS), Simple Mail Transfer Protocol (SMTP), Simple Network Management Protocol (SNMP), Transmission Control Protocol/Internet Protocol (TCP/IP), User Datagram Protocol (UDP), Lightweight Directory Access Protocol (LDAP), and the Message Queue (MQ) family of network protocols.

Network 104 may be configured to allow communication between print server 106 and one or more printing devices 102, between the printing devices 102 themselves, and/or between one or more other devices or systems and the system 100. Such communications may include commands, requests, and/or data corresponding to documents, printing-device errors, and/or other data.

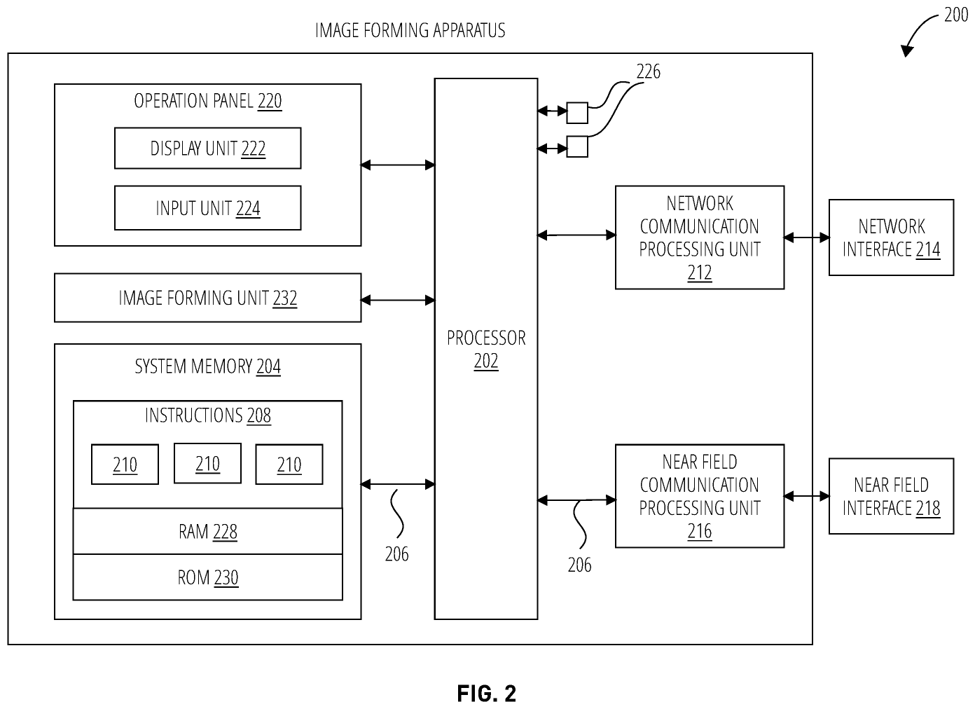

FIG. 2 illustrates a printing device described as an image forming apparatus 200. The image forming apparatus 200 may be described in more detail in terms of the machine elements that provide functionality to the systems and methods disclosed herein. The components of the image forming the image forming apparatus 200 may include, but are not limited to, one or more processors 202, a system memory 204, and a system bus 206 that may couple various system components including the system memory 204 to the processor 202. The image forming apparatus 200 may typically include a variety of computer system readable media. Such media could be chosen from any available media that is accessible by the image forming apparatus 200, including non-transitory, volatile and non-volatile media, removable and non-removable media, and read only memory or ROM 230. The system memory 204 could include one or more image forming device readable media in the form of volatile memory, such as a random access memory or RAM 228 and/or a cache memory. By way of example, the system memory 204 may be provided for reading from and writing to a non-removable, non-volatile magnetic media device typically called a “hard drive.”

The system memory 204 may include at least one program product/utility or instructions 208, having a set (e.g., at least one) of program modules 210 that may be configured to carry out the functions of embodiments of the disclosure. The program modules 210 may include, but is not limited to, an operating system, one or more application programs, other program modules, and program data. Each of the operating systems, one or more application programs, other program modules, and program data or some combination thereof, may include an implementation of a networking environment. The program modules 210 may include procedures such as a page converter, rasterizer, compression code, page print scheduler, print engine manager, and similar printing applications (i.e., printer firmware). The program modules 210 generally carry out the functions and/or methodologies of embodiments of the disclosure as described herein.

The image forming apparatus 200 may have one or more communication modules. The communication modules may allow the image forming apparatus 200 to communicate with one or more networks (i.e., network 104 introduced in FIG. 1 such as a local area network (LAN), a general wide area network (WAN), wireless local area network (WLAN) and/or a public network. In accordance with one embodiment, the communication modules may include a network communication processing unit 212 coupled to a network interface 214. The network communication processing unit 212 and the network interface 214 may allow the image forming apparatus 200 to communicate with one or more networks. These networks may be a local area network (LAN), a general wide area network (WAN), a wireless local area network, a public network, a cellular network as well as other type of networks. The communication modules may include a near field communication processing unit 216 coupled to a near field interface 218. The near field communication processing unit 216 and the near field interface 218 may allow the image forming apparatus 200 to communicate with other electronic devices located near the image forming apparatus 200 using Bluetooth, infrared or similar wireless communication protocols.

The image forming apparatus 200 may include an operation panel 220. The operation panel 220 may include a display unit 222 and an input unit 224 for facilitating human interaction with the image forming apparatus 200. The display unit 222 may be any electronic video display, such as a LCD display, LED display and similar display types. The input unit 224 may include any combination of devices that allows users to input information into the operation panel 220, such as buttons, a keyboard, switches, and/or dials. In addition, the input unit 224 may include a touch-screen digitizer overlaid onto the display unit 222 that can sense touch and interact with the display unit 222.

The image forming apparatus 200 may have one or more sensors 226. Each sensor 226 may be used to monitor certain operating conditions of the image forming apparatus 200. Sensors 226 may be used to indicate a location of a paper jam, document mis-feed, toner level, as well as other operating conditions. The above is given as examples and should not be read in a limiting manner. Each sensor 226 may be coupled to the processor 202. When a sensor 226 detects an operational issue as may be disclosed below, the sensor 226 may send a signal to the processor 202. The processor 202 may generate an error alert associated with the operational issue. The processor 202 may transmit the error alert to an external device using one of the communication modules.

The image forming unit 232 may be a logical module residing outside of system memory 204 and the processor 202 as shown, but may in some embodiments be incorporated within the processor 202, and may act upon one or more program modules 210 stored in system memory 204. The image forming unit 232 may include or connect to hardware that captures images within a physical document and converts these to data, such as a scanning device. The image forming unit 232 may also act upon data provided from system memory 204 or the communication modules representing pages and images of a scanned or digitally created file. The image forming unit 232 may provide rendering logic, rasterization logic, color conversion logic, etc., as well as logic to implement the disclosed solution.

As will be appreciated by one skilled in the art, aspects of this disclosure may be embodied as a system, method or process, or computer program product. Accordingly, aspects of this disclosure may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of this disclosure may take the form of a computer program product embodied in one or more computer readable media having computer readable program code embodied thereon.

Any combination of one or more computer readable media (for example, system memory 204) may be utilized. In the context of this disclosure, a computer readable storage medium may be any tangible or non-transitory medium that can contain, or store a program (for example, the program modules 210) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

A method 500 of predicting of toner replacements with logistic regression involves collecting toner level data for a print cartridge in a printing device, during a current replacement cycle of the print cartridge, at toner level data intervals, the toner level data comprising a volume percentage of toner in the print cartridge as time series level data points (block 502). In block 504, the method 500 collects print volume data of the printing device, during the current replacement cycle of the print cartridge, at a print volume data interval, the print volume data comprising a number of pages printed during the print volume data interval as time series volume data points. In block 506, the method 500 applies the toner level data and the print volume data as input variables to a predetermined regression learning process. In the method 500, the predetermined regression learning process includes a regression model and determines a number of predicted days until the print cartridge requires replacement. In the method 500, the predetermined regression learning process outputs a predicted number of analytical intervals until the print cartridge needs to be replaced. In the method 500, the predicted number of analytical intervals is the number of predicted days until the print cartridge requires replacement divided by an analytical interval. In the method 500, the analytical interval is a discrete interval of time during a life cycle of the print cartridge. In block 508, the method 500 triggers a replacement process for the print cartridge on condition that the predicted number of analytical intervals satisfies a threshold.

In some configurations of the method 500, the regression model includes a decision tree algorithm. In this configuration, the regression model may be a Random Forest model.

In some configurations of the method 500, the threshold is satisfied when the predicted number of analytical intervals equals two or less.

In some configurations of the method 500, the print cartridge includes multiple colors, the toner level data and the print volume data are collected for each color of the print cartridge, and the predetermined regression learning process applies the regression model to the toner level data and the print volume data on a color-by-color basis.

In some configurations of the method 500, the print volume data includes at least three data points during the print volume data interval.

In some configurations of the method 500, the toner level data includes at least three data points during the toner level data interval.

In some configurations of the method 500, the analytical interval is at least one week. In this configuration, the prior customer use for a particular customer may determine the analytical interval for the print cartridges of the particular customer

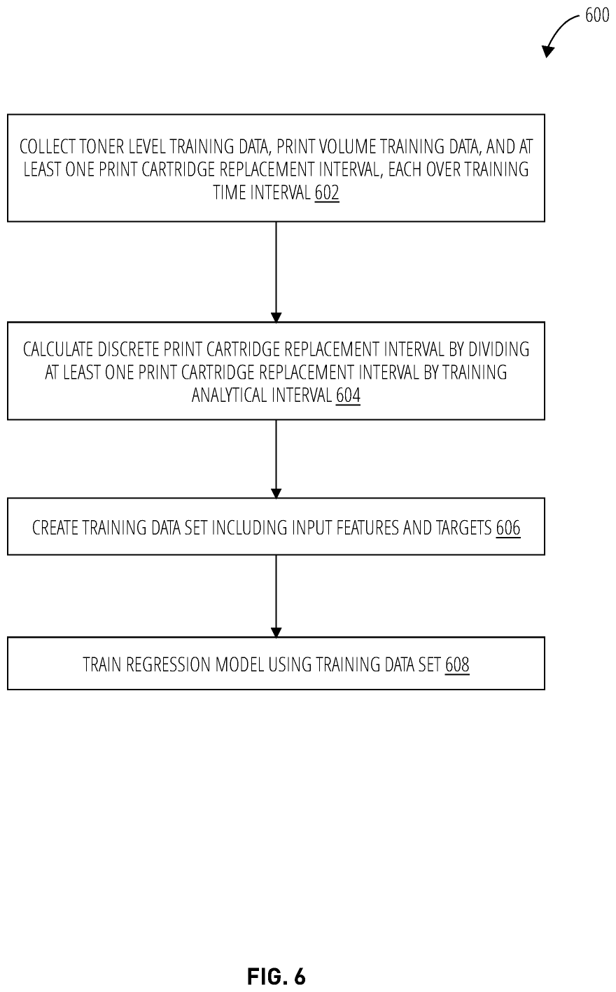

In FIG. 6, a method 600 for training the predetermined regression learning process involves collecting toner level training data, print volume training data, and at least one print cartridge replacement interval, each over a training time interval (block 602). In the method 600, the toner level training data comprises the volume % of toner in the print cartridge as time series level data points. In the method 600, the print volume training data comprises the number of pages printed during the print volume data interval as time series volume data points. In block 604, the method 600 calculates a discrete print cartridge replacement interval by dividing the at least one print cartridge replacement interval by a training analytical interval, wherein the training analytical interval is a discrete training interval of time during at least one life cycle of the print cartridge. In block 606, the method 600 creates a training data set including input features and targets. The training data set includes the toner level training data, the print volume training data, and the discrete print cartridge replacement interval. In block 608, the method 600 trains the regression model using the training data set, wherein the discrete print cartridge replacement interval is at least one input feature as well as at least one target, thereby creating a trained regression model.

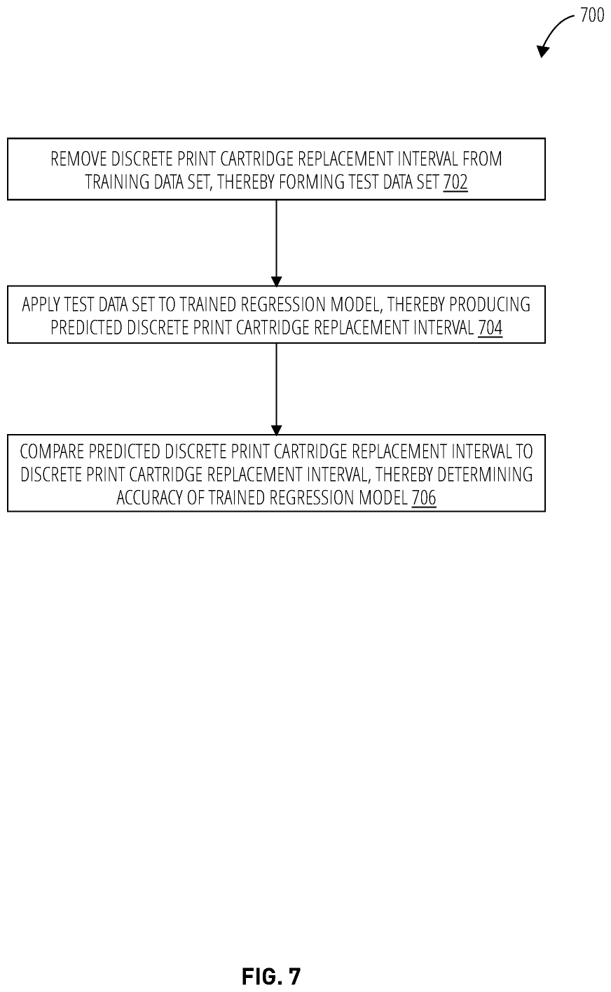

FIG. 7 illustrates further aspects of the method 600 described as method 700. In the method 700, the discrete print cartridge replacement interval is removed from the training data set, thereby forming a test data set (block 702). In block 704, the method 700 applies the test data set to the trained regression model, thereby producing a predicted discrete print cartridge replacement interval. In block 706, the method 700 compares the predicted discrete print cartridge replacement interval to the discrete print cartridge replacement interval, thereby determining an accuracy of the trained regression model.

Regression is a method of modelling a target value based on independent predictors. This method is mostly utilized for forecasting and determining cause and effect relationship between variables. Regression techniques mostly differ based on the number of independent variables and the type of relationship between the independent and dependent variables.

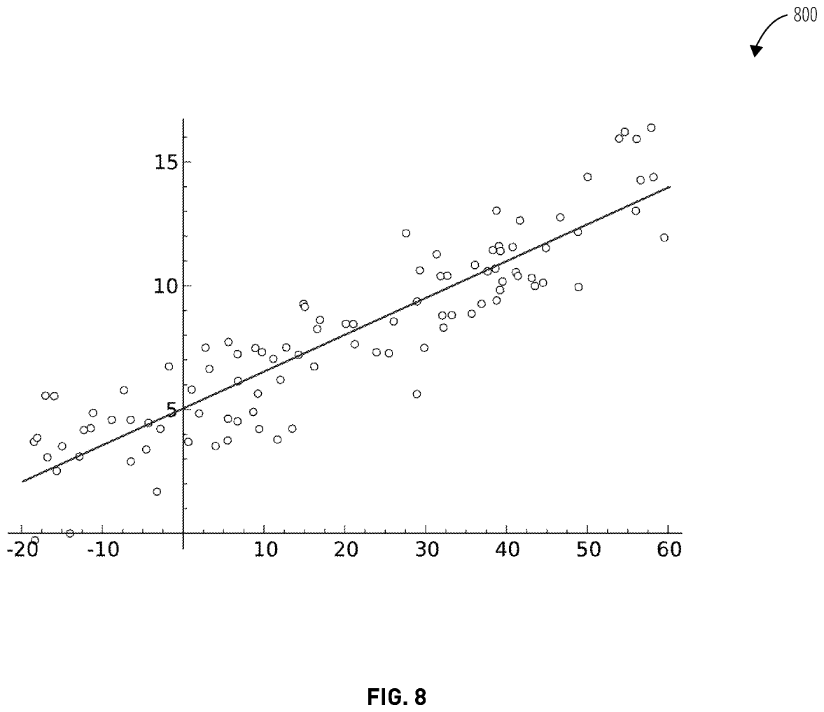

Simple linear regression is a type of regression analysis where the number of independent variables is one and there is a linear relationship between the independent(x) and dependent(y) variable. Referencing FIG. 8, the line in the graph 800 is referred to as the best fit straight line. Based on the given data points, a line is plotted that models the points the best. The line may be modelled based on the linear equation y=α₀+α₁*x.

The motive of the linear regression algorithm is to find the best values for α₀ and α₁.

Regression analysis includes a set of machine learning methods that allows for the prediction of a continuous outcome variable (y) based on the value of one or multiple predictor variables (x).

The goal of a regression model is to build a mathematical equation that defines y as a function of the x variables. This equation may be utilized to predict the outcome (y) on the basis of new values of the predictor variables (x).

Linear regression is a technique for predicting a continuous variable. It assumes a linear relationship between the outcome and the predictor variables.

The linear regression equation may be written as y=b0+b*x+e, where:

b0 is the intercept,

b is the regression weight or coefficient associated with the predictor variable x.

e is the residual error

Technically, the linear regression coefficients are determined so that the error in predicting the outcome value is minimized. This method of computing the beta coefficients is called the Ordinary Least Squares method.

When there are multiple predictor variables, say x1 and x2, the regression equation may be written as y=b0+b1*x1+b2*x2+e. In some situations, there might be an interaction effect between some predictors, that is for example, increasing the value of a predictor variable x1 may increase the effectiveness of the predictor x2 in explaining the variation in the outcome variable. Note also that, linear regression models can incorporate both continuous and categorical predictor variables.

When building a linear regression model, diagnostics are performed to determine whether linear model is suitable for a data set. In some cases, the relationship between the outcome and the predictor variables may not be linear. In these situations, a non-linear regression, such as polynomial and spline regression, may be utilized.

When there are multiple predictors in the regression model, it may be necessary to select the best combination of predictor variables to build an optimal predictive model. This process is called model selection, and includes comparing multiple models containing different sets of predictors in order to select the best performing model that minimize the prediction error. Linear model selection approaches include best subsets regression and stepwise regression.

In some situations, such as in genomic fields, a data set may be a large multivariate data set containing some correlated predictors. In this case, the information, in the original data set, may be summarized into few new variables (called principal components) that are a linear combination of the original variables. This few principal components may be used to build a linear model, which might be more performant for the data. This approach is known as principal component-based methods, which includes principal component regression and partial least squares regression.

An alternative method to simplify a large multivariate model is to use penalized regression, which penalizes the model for having too many variables. The most well known penalized regressions include ridge regression and the lasso regression.

Although all these different regression models can be applied to a data set, comparison of the models may be needed to select the best approach that best explains data-set. To do so, statistical metrics may be utilized to compare the performance of the different models in explaining the data set and in predicting the outcome of new test data.

The best model may be defined as the model that has the lowest prediction error. The most popular metrics for comparing regression models, include:

Root Mean Squared Error, which measures the model prediction error. It corresponds to the average difference between the observed known values of the outcome and the predicted value by the model. RMSE is computed as RMSE=mean((observed−predicted)\hat{ }2) %>% sqrt( ) The lower the RMSE, the better the model.

Adjusted R-square, representing the proportion of variation (i.e., information), in the data set, explained by the model. This corresponds to the overall quality of the model. The higher the adjusted R2, the better the model

Note that, the above mentioned metrics should be computed on a new test data that has not been used to train (i.e., build) the model. If using a large data set with many records, the data can be split into training set (80% for building the predictive model) and test set or validation set (20% for evaluating the model performance).

One of the most robust and popular approach for estimating a model performance is k-fold cross-validation. It may be applied even on a small data set. k-fold cross-validation works as follows:

1. Randomly split the data set into k-subsets (or k-fold) (for example 5 subsets)

2. Reserve one subset and train the model on all other subsets

3. Test the model on the reserved subset and record the prediction error

4. Repeat this process until each of the k subsets has served as the test set.

5. Compute the average of the k recorded errors. This is called the cross-validation error serving as the performance metric for the model.

Taken together, the best model may be the model that has the lowest cross-validation error, RMSE.

To better understand linear regression, the concepts of a cost function and gradient descent are explained below.

The cost function is useful for determining the best possible values for α₀ and α₁ which would provide the best fit line for the data points. To determine the best values for α₀ and α₁, the search problem is converted into a minimization problem where the objective is to minimize the error between the predicted value and the actual value.

$$minimize \frac{1}{n} {\sum }_{i = 1}^{n} {( p r e {d}_{i} - {i}_{} )}^{2} \qquad function 1$$

$$J = \frac{1}{n} {\sum }_{i = 1}^{𝔫} {( p r e {d}_{i} - {i}_{} )}^{2}$$

The function above (function 1) was selected to illustrate the minimization problem. The difference between the predicted values and ground truth measures the error difference. The error difference is squared, then all data points summed up and the value is then divided by the total number of data points. This provides the average squared error over all the data points. Therefore, this cost function is also known as the Mean Squared Error(MSE) function. Utilizing this MSE function the values of α₀ and α₁ are changed such that the MSE value settles at the minima.

Gradient descent is a method of updating α₀ and α₁ to reduce the cost function(MSE). It is a process of optimizing the values of the coefficients by iteratively minimizing the error of the model on the training data. The idea is to start with some values for α₀ and α₁ and then change these values iteratively to reduce the cost. Gradient descent helps to determine how to change the values.

Gradient descent works by starting with random values for each coefficient. The sum of the squared errors are calculated for each pair of input and output values. A learning rate is used as a scale factor and the coefficients are updated in the direction towards minimizing the error. The process is repeated until a minimum sum squared error is achieved or no further improvement is possible.

In this method, a learning rate (alpha) parameter is selected that determines the size of the improvement step taken on each iteration of the procedure.

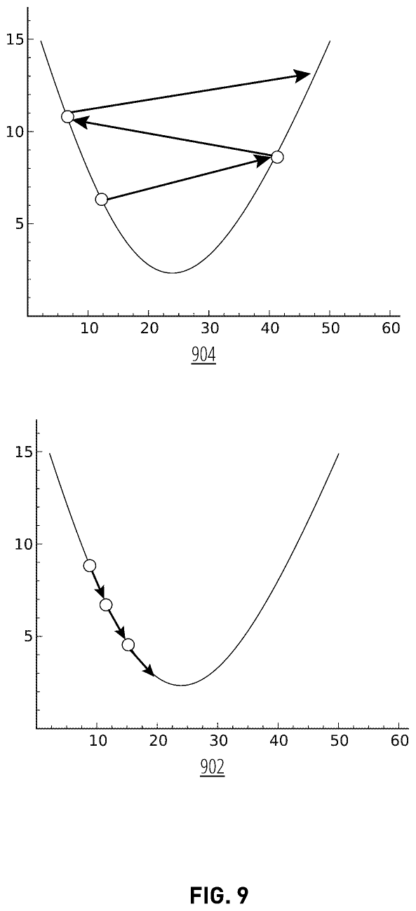

To draw an analogy, imagine a pit in the shape of U and you are standing at the topmost point in the pit and your objective is to reach the bottom of the pit. There is a catch, you can only take a discrete number of steps to reach the bottom. If you decide to take one step at a time you would eventually reach the bottom of the pit but this would take a longer time. If you choose to take longer steps each time, you would reach sooner but, there is a chance that you could overshoot the bottom of the pit and not exactly at the bottom. In the gradient descent algorithm, the number of steps taken is the learning rate. This decides on how fast the algorithm converges to the minima. This concept is illustrated in FIG. 9 where graph 904 illustrates a big learning rate the overshoots the minima, and graph 902 illustrates a small learning rate as it approaches the minima.

In some situations, the cost function may be a non-convex function where there may be local minima but for linear regression, it is generally a convex function.

To update α₀ and α₁ utilizing gradient descent, gradients are taken from the cost function. To find these gradients, partial derivatives are taken with respect to α₀ and α₁. An example of how to identify the partial derivatives are found in the equations below

$$J = \frac{1}{n} {\sum }_{i = 1}^{n} {( p r e {d}_{i} - {i}_{} )}^{2}$$

$$J = \frac{1}{n} {\sum }_{i = 1}^{n} {( {a}_{0} + {a}_{1} \cdot {x}_{i} - {i}_{} )}^{2}$$

$$\frac{\partial J}{\partial {a}_{0}} = \frac{2}{n} {\sum }_{i = 1}^{𝔫} ( {a}_{0} + {a}_{1} \cdot {x}_{i} - {i}_{} ) ⇒ \frac{\partial J}{\partial {a}_{0}} = \frac{2}{n} {\sum }_{i = 1}^{n} ( p r e {d}_{i} - {i}_{} )$$

$$\frac{\partial J}{\partial {a}_{1}} = \frac{2}{n} {\sum }_{i = 1}^{n} ( {a}_{0} + {a}_{1} \cdot {x}_{i} - {i}_{} ) \cdot {x}_{i} ⇒ \frac{\partial J}{\partial {a}_{1}} = \frac{2}{n} {\sum }_{i = 1}^{n} ( p r e {d}_{i} - {i}_{} ) \cdot {x}_{i}$$

$${a}_{0} = {a}_{0} - α \cdot \frac{2}{n} {\sum }_{i = 1}^{n} ( p r e {d}_{i} - {i}_{} )$$

$${a}_{1} = {a}_{1} - α \cdot \frac{2}{n} {\sum }_{i = 1}^{n} ( p r e {d}_{i} - {i}_{} ) \cdot {x}_{i}$$

The partial derivates are the gradients and they are utilized to update the values of α₀ and α₁. Alpha is the learning rate which is a hyperparameter that requires a user to specify. Selecting a smaller learning rate may converge at the minima with more accurate results but at the cost of more time, while selecting a larger learning rate may converge sooner but there is a chance that to overshoot the minima.

Gradient descent is often taught using a linear regression model because it is relatively straightforward to understand. In practice, it is useful when implemented with a very large dataset either in the number of rows or the number of columns that may not fit into memory.

Decision tree algorithms belong to the family of supervised learning algorithms. Unlike other supervised learning algorithms, decision tree algorithms can be used for solving regression and classification problems.

A general motive for using decision tree learning is to create a training model which can be used to predict class or value of target variables by learning decision rules inferred from prior data (training data).

Decision tree learning is one of the predictive modelling approaches used in statistics, data mining and machine learning. It uses a decision tree (as a predictive model) to go from observations about an item (represented in the branches) to conclusions about the item's target value (represented in the leaves). Tree models where the target variable can take a discrete set of values are called classification trees. In these tree structures, leaves represent class labels and branches represent conjunctions of features that lead to those class labels. Decision trees where the target variable can take continuous values (typically real numbers) are called regression trees. Decision trees are among the most popular machine learning algorithms given their intelligibility and simplicity.

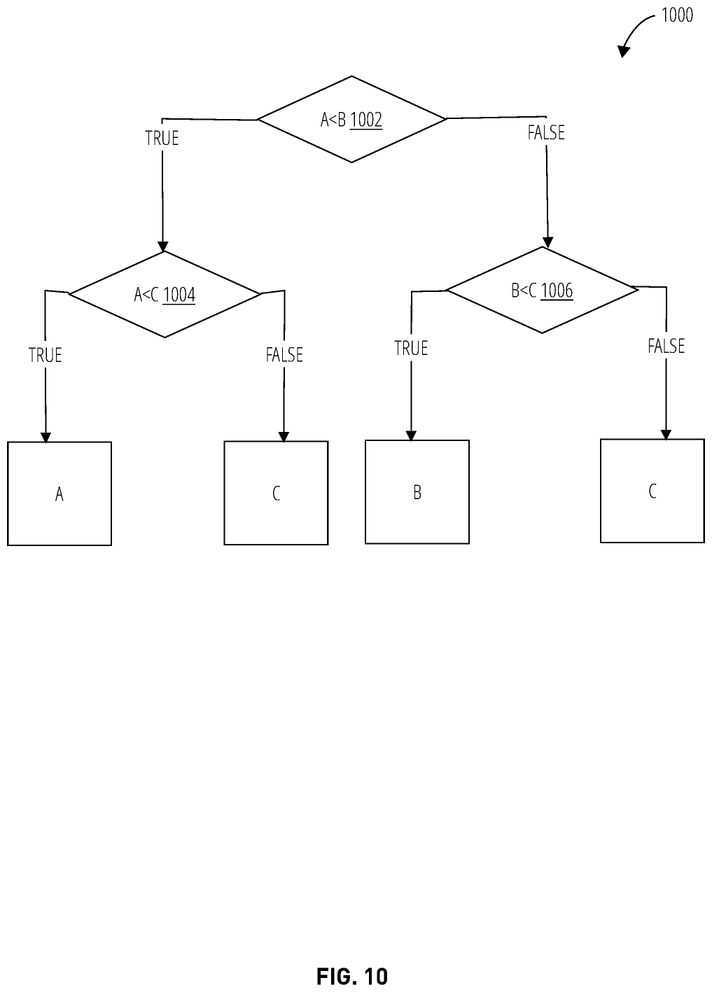

FIG. 10 illustrates an example decision tree 1000. The decision tree 1000 is shown with decision blocks representing nodes that branch based on the truth or falsity of statement in the decision node. In the decision tree 1000, the decision block 1002 makes the statement that “A<B”, if this statement is true the decision branch is followed to decision block 1004 or decision block 1006 if the statement is false. If the statement was true, decision block 1004 presents the statement “A<C” which branches into end nodes ending with either A, if the statement is true, or C, if the statement is false. Similarly, if the statement was false, the decision block 1006 presents the statement “B<C” which branches into end nodes ending with either B, if the decision is true, or C, if the statement is false.

In decision analysis, a decision tree can be used to visually and explicitly represent decisions and decision making. In data mining, a decision tree describes data (but the resulting classification tree can be an input for decision making). The goal is to create a model that predicts the value of a target variable based on several input variables.

A decision tree is a simple representation for classifying examples. For this example, assume that all of the input features have finite discrete domains, and there is a single target feature called the “classification.” Each element of the domain of the classification is called a class. A decision tree or a classification tree is a tree in which each internal (non-leaf) node is labeled with an input feature. The arcs coming from a node labeled with an input feature are labeled with each of the possible values of the target feature or the arc leads to a subordinate decision node on a different input feature. Each leaf of the tree is labeled with a class or a probability distribution over the classes, signifying that the data set has been classified by the tree into either a specific class, or into a particular probability distribution (which, if the decision tree is well-constructed, is skewed towards certain subsets of classes).

A tree is built by splitting the source set, constituting the root node of the tree, into subsets—which constitute the successor children. The splitting is based on a set of splitting rules based on classification features. This process is repeated on each derived subset in a recursive manner called recursive partitioning. The recursion is completed when the subset at a node has all the same values of the target variable, or when splitting no longer adds value to the predictions. This process of top-down induction of decision trees (TDIDT) is an example of a greedy algorithm, and it is by far the most common strategy for learning decision trees from data.

In data mining, decision trees can be described also as the combination of mathematical and computational techniques to aid the description, categorization and generalization of a given set of data.

Data comes in records of the form:

( [symbol] ,Y)=(x₁,x₂,x₃, . . . , [symbol] ,Y)

The dependent variable, Y, is the target variable that one is trying to understand, classify or generalize. The vector [symbol] is composed of the features x₁, x₂, x₃, etc. that are used for that task.

There are many types of decision trees that may be utilized that vary depending on their purpose. In data mining, there are of two main types of decision trees, a classification tree and a regression tree. A classification tree analysis occurs where the predicted outcome is the class (discrete) to which the data belongs. A regression tree analysis occurs where the predicted outcome can be considered a real number (e.g. the price of a house, or a patient's length of stay in a hospital).

The term Classification And Regression Tree (CART) analysis is an umbrella term used to refer to both of the above procedures. Trees used for regression and trees used for classification have some similarities—but also some differences, such as the procedure used to determine where to split.

Another type of decision tree is a decision stream. Decision streams avoid the problems of data exhaustion and formation of unrepresentative data samples in decision tree nodes by merging the leaves from the same and/or different levels of predictive model structure. With an increasing of the number of samples in nodes and a reducing of the tree width, decision streams preserve statistically representative data and allow extremely deep graph architecture that can consist of hundreds of levels.

Some techniques, often called ensemble methods, construct more than one decision tree. An example of these are boosted trees and boostrap aggregated trees. Boosted trees incrementally build an ensemble by training each new instance to emphasize the training instances previously mismodeled. A typical example is AdaBoost (i.e., Adaptive Boosting). These can be used for regression-type and classification-type problems. Bootstrap aggregated (or bagged) decision trees build multiple decision trees by repeatedly resampling training data with replacement, and voting the trees for a consensus prediction. A specific type of bootstrap aggregated decision trees is a random forest classifier.

Algorithms for constructing decision trees usually work top-down, by choosing a variable at each step that best splits the set of items. Different algorithms use different metrics for measuring “best” results. These generally measure the homogeneity of the target variable within the subsets. One example of a metric is Gini impurity.

Gini impurity is utilized by the CART (classification and regression tree) algorithm for classification trees and as a measure of how often a randomly chosen element from the set would be incorrectly labeled if it was randomly labeled according to the distribution of labels in the subset. The Gini impurity can be computed by summing the probability [symbol] of an item with label [symbol] being chosen times the probability

$$= 1 - {i}_{}$$

of a mistake in categorizing that item. It reaches its minimum (zero) when all cases in the node fall into a single target category.

The Gini impurity is also an information theoretical measure and corresponds to Tsallis Entropy with deformation coefficient [symbol] =2, which in physics is associated with the lack of information in out-of-equilibrium, non-extensive, dissipative and quantum systems. For the limit [symbol] →1 one recovers the usual Boltzmann-Gibbs or Shannon entropy. In this sense, the Gini impurity is but a variation of the usual entropy measure for decision trees.

To compute Gini impurity for a set of items with J classes, suppose [symbol] ∈{1, 2, . . . , J}, and let [symbol] be the fraction of items labeled with class i in the set.

$${I}_{G} ( p ) = {\sum }_{i = 1}^{J} {p}_{i} {\sum }_{k \neq i} {p}_{k} = {\sum }_{i = 1}^{J} {p}_{i} ( 1 - {p}_{i} ) = {\sum }_{i = 1}^{J} ( {p}_{i} - {p}_{i}^{2} ) = {\sum }_{i = 1}^{J} {p}_{i} - {\sum }_{i = 1}^{J} {p}_{i}^{2} = 1 - {\sum }_{i = 1}^{J} {p}_{i}^{2}$$

Some of the advantages of using decisions trees are:

Ability to handle both numerical and categorical data compared to other techniques that are usually specialized in analyzing datasets that have only one type of variable. (For example, relation rules can be used only with nominal variables while neural networks can be used only with numerical variables or categorical converted to 0-1 values.)

Little data preparation is required compared to other techniques that often require data normalization. Since trees can handle qualitative predictors, there is no need to create dummy variables.

Uses a white box or open-box model. If a given situation is observable in a model the explanation for the condition is easily explained by Boolean logic. By contrast, in a black box model, the explanation for the results is typically difficult to understand, for example with an artificial neural network.

Possible to validate a model using statistical tests. That makes it possible to account for the reliability of the model.

Non-statistical approach that makes no assumptions of the training data or prediction residuals; e.g., no distributional, independence, or constant variance assumptions

Performs well with large datasets. Large amounts of data can be analyzed using standard computing resources in reasonable time.

Mirrors human decision making more closely than other approaches. This may be useful when modeling human decisions/behavior.

Robust against co-linearity, particularly boosting

In built feature selection. Additional irrelevant features will be less used so that they can be removed on subsequent runs. The hierarchy of attributes in a decision tree reflects the importance of attributes. It means that the features on top are the most informative.

Decision trees can approximate any Boolean function XOR.

Random forests or random decision forests are an ensemble learning method for classification, regression and other tasks that operate by constructing a multitude of decision trees at training time and outputting the class that is the mode of the classes (classification) or mean prediction (regression) of the individual trees. Random decision forests correct for the decision trees' tendency of overfitting to their training set.

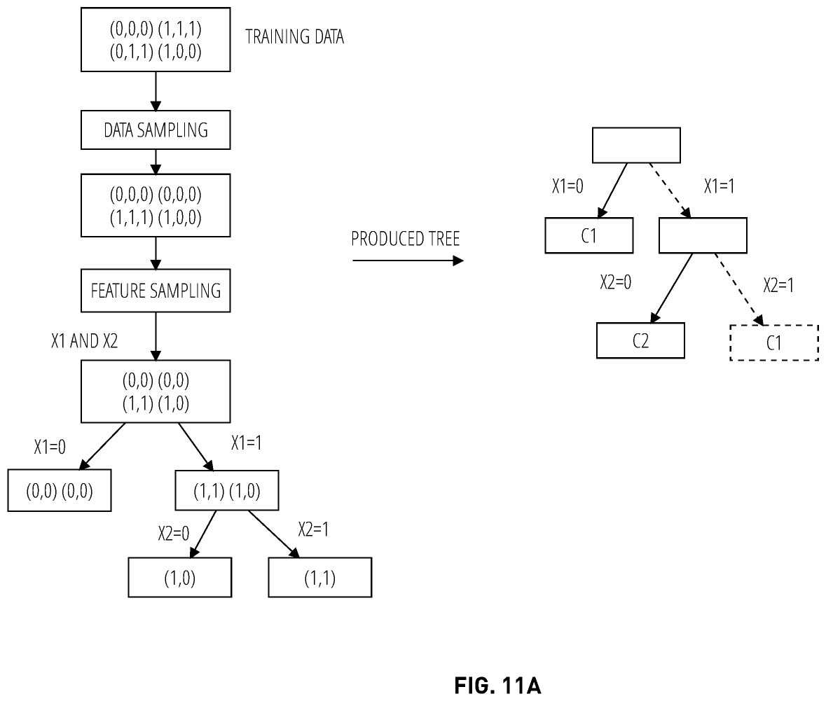

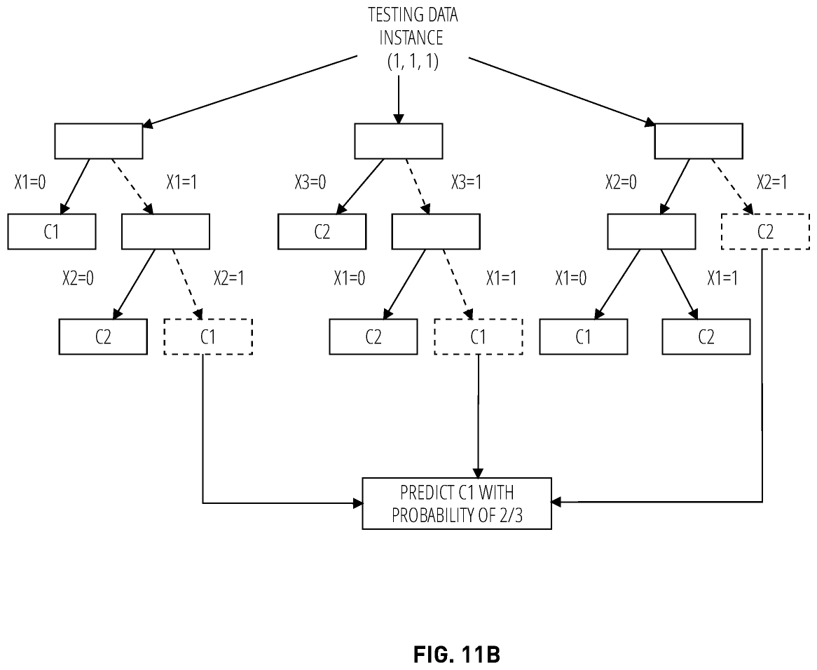

FIG. 11A and FIG. 11B illustrate a simplified process for building a random forest and then applying the random forest for testing a data instance.

TABLE 3

| X1 | X2 | X3 | Class |
|---|---|---|---|
| 0 | 0 | 0 | c1 |
| 1 | 1 | 1 | c1 |
| 0 | 1 | 1 | c2 |
| 1 | 0 | 0 | c2 |

Table 3 illustrates a simplified data set with two classifications (i.e., c1 and c2)

In FIG. 11A the data from Table 3 is provided as training data that is then used for data sampling. A random sampling of the original data is taken in the data sampling process. In FIG. 11A the random sampling takes the two samples of the first data set (0,0,0) with a class of c1, one sample of the second data set (1,1,1) with class c1, and one sample of the fourth data set (1,0,0) with the class of c2. In total, the randomly sampled sets represent three c1 class data and one c2 class data. The randomly sampled data sets then undergo random feature sampling, which randomly selects the x1 and x2 data features producing the data sets of (0,0), (0, 0), (1,1), and (1,0). The data set is then entered into a decision tree that randomly tests the features at each node. For example, the first branch tests for values of x1, where it branches to x1=0 for data (0,0) and (0,0) as they are values of x and can be classified as c1 data, and x1=1 for data (1,1) (1,0). This data set contains both c1 and c2 data and is then further classified in another branch. The branch for x1=1 branches to x2=0 for data (1,0), which is classified as c2 data, and x2=1 for data (1,1), which is classified as c1 data. These decision trees inherently carry two types of randomness built in. First, each tree is built on a random sample from the original data. Second, at each tree node, a subset of features is randomly selected to generate the best split. This process is repeated to produce multiple random decision trees as seen in FIG. 11B.

FIG. 11B is provided as a simplified view of how a random forest algorithm operates to generate a classification. The process begins with a testing data instance with value (1,1,1) and is processed to three different trees that test the three different features x1, x2, and x3. The first tree receives the instance where classification is branched based on x1=0 and x1=1. As there are no x1=0 values the classification for the branch terminates and moves to the next branch classifying the next value in the set corresponding to x2. In this branch, the instance is tested against x2=0 and x2=1. Since x2=1 is identified, two classifications for the testing data are determined as corresponding to c1 data. In the next tree, the test data is tested against the x3 value where x3=0 and x3=1. The test for x3=1 identifies a match and tests the next value of x1 where the branch is x1=0 and x1=1. Since x1=1, the classification ends as the two values for x3 and x1 correspond to c1 data. The third tree classifies the data starting with the x2=0 and x2=1 and identifies the classification for the data as c2. The outcome of these trees is then utilized to predict a c1 classification with a probability of 2/3 for the three trees.

In particular, trees that are grown very deep tend to learn highly irregular patterns: they overfit their training sets, i.e. have low bias, but very high variance. Random forests are a way of averaging multiple deep decision trees, trained on different parts of the same training set, with the goal of reducing the variance. This comes at the expense of a small increase in the bias and some loss of interpretability, but generally greatly boosts the performance in the final model.

Forests are like the pulling together of decision tree algorithm efforts. Taking the teamwork of many trees and thus improving the performance of a single random tree. Though not quite similar, forests give the effects of a K-fold cross validation.

One algorithm utilized for random forest is bagging. Bagging is a training algorithm that for random forests applies the general technique of bootstrap aggregating, or bagging, to tree learners. Given a training set X=x₁, . . . , xₙ with responses Y=y₁, . . . , yₙ, bagging repeatedly (B times) selects a random sample with replacement of the training set and fits trees to these samples:

For b=1, . . . ,B:

the process is to:
1. Sample, with replacement, n training examples from X, Y; (referred to as X_{b}, Y_{b}).
2. Train a classification or regression tree f_{b} on X_{b}, Y_{b}.

After training, predictions for unseen samples x′ can be made by averaging the predictions from all the individual regression trees on x′:

$$\hat{f} = \frac{1}{B} {\sum }_{b = 1}^{B} {f}_{b} ( {x}^{′} )$$

Alternatively, the prediction for unseen samples x′ can be made by taking the majority vote in the case of classification trees.

This bootstrapping procedure leads to better model performance because it decreases the variance of the model, without increasing the bias. This means that while the predictions of a single tree are highly sensitive to noise in its training set, the average of many trees is not, as long as the trees are not correlated. Simply training many trees on a single training set would give strongly correlated trees (or even the same tree many times, if the training algorithm is deterministic). Bootstrap sampling is a way of de-correlating the trees by showing them different training sets.

Additionally, an estimate of the uncertainty of the prediction can be made as the standard deviation of the predictions from all the individual regression trees on x′:

$$σ = \sqrt{\frac{{\sum }_{b = 1}^{B} {( {f}_{b} ( {x}^{′} ) - \hat{f} )}^{2}}{B - 1}}$$

The number of samples/trees, B, is a free parameter. Typically, a few hundred to several thousand trees are used, depending on the size and nature of the training set. An optimal number of trees B can be found using cross-validation, or by observing the out-of-bag error: the mean prediction error on each training sample xᵢ, using only the trees that did not have xᵢ in their bootstrap sample. The training and test error tend to level off after some number of trees have been fit.

The above procedure describes the original bagging algorithm for trees. Random forests differ in only one way from this general scheme: they use a modified tree learning algorithm that selects, at each candidate split in the learning process, a random subset of the features. This process is sometimes called “feature bagging.” The reason for doing this is the correlation of the trees in an ordinary bootstrap sample: if one or a few features are very strong predictors for the response variable (target output), these features will be selected in many of the B trees, causing them to become correlated.

Typically, for a classification problem with p features, [symbol] (rounded down) features are used in each split. For regression problems, one embodiment recommends p/3 (rounded down) with a minimum node size of 5 as the default. In practice the best values for these parameters will depend on the problem, and they should be treated as tuning parameters.

Adding one further step of randomization yields extremely randomized trees, or ExtraTrees. While similar to ordinary random forests in that they are an ensemble of individual trees, there are two main differences: first, each tree is trained using the whole learning sample (rather than a bootstrap sample), and second, the top-down splitting in the tree learner is randomized. Instead of computing the locally optimal cut-point for each feature under consideration (based on, e.g., information gain or the Gini impurity), a random cut-point is selected. This value is selected from a uniform distribution within the feature's empirical range (in the tree's training set). Then, of all the randomly generated splits, the split that yields the highest score is chosen to split the node. Similar to ordinary random forests, the number of randomly selected features to be considered at each node can be specified. Default values for this parameter are [symbol] for classification and [symbol] for regression, where [symbol] is the number of features in the model.

A feature's importance score measures the contribution from the feature. It is based on the impurity reduction of the class due to the feature.

After training a random forest, it is natural to ask which variables have the most predictive power. Variables with high importance are drivers of the outcome and their values have a significant impact on the outcome values. By contrast, variables with low importance might be omitted from a model, making it simpler and faster to fit and predict.

There are two measures of importance given for each variable in the random forest. The first measure is based on how much the accuracy decreases when the variable is excluded. This is further broken down by outcome class. The second measure is based on the decrease of Gini impurity when a variable is chosen to split a node.

Each tree has its own out-of-bag sample of data that was not used during construction. This sample is used to calculate importance of a specific variable. First, the prediction accuracy on the out-of-bag sample is measured. Then, the values of the variable in the out-of-bag-sample are randomly shuffled, keeping all other variables the same. Finally, the decrease in prediction accuracy on the shuffled data is measured.

The mean decrease in accuracy across all trees is reported. This importance measure is also broken down by outcome class. Intuitively, the random shuffling means that, on average, the shuffled variable has no predictive power. This importance is a measure of by how much removing a variable decreases accuracy, and vice versa—by how much including a variable increases accuracy.

Note that if a variable has very little predictive power, shuffling may lead to a slight increase in accuracy due to random noise. This in turn can give rise to small negative importance scores, which can be essentially regarded as equivalent to zero importance.

When a tree is built, the decision about which variable to split at each node uses a calculation of the Gini impurity. The Gini impurity can be computed by summing the probability [symbol] of an item with label [symbol] being chosen times the probability

$$= 1 - {i}_{}$$

of a mistake in categorizing that item. It reaches its minimum (zero) when all cases in the node fall into a single target category.

For each variable, the sum of the Gini decrease across every tree of the forest is accumulated every time that variable is chosen to split a node. The sum is divided by the number of trees in the forest to give an average. The scale is irrelevant: only the relative values matter.

When features are similar to each other, the importance scores of these features can be misleading. In the illustrative dataset, X2 and X3 are identical and they “share” the importance scores (shown the left figure below). When there are more redundant features, the importance of each feature becomes even smaller.

This may not hurt the accuracy performance but could be misleading in interpretation. One solution would be the regularized random forest (RRF). In the tree building process, RRF memorizes the features used in previous tree nodes, and prefers these features in splitting future tree nodes, therefore avoiding redundant features in the trees.

As part of their construction, random forest predictors naturally lead to a dissimilarity measure among the observations. One can also define a random forest dissimilarity measure between unlabeled data. The idea is to construct a random forest predictor that distinguishes the “observed” data from suitably generated synthetic data. The observed data is the original unlabeled data and the synthetic data is drawn from a reference distribution. A random forest dissimilarity can be attractive because it handles mixed variable types very well, is invariant to monotonic transformations of the input variables, and is robust to outlying observations. The random forest dissimilarity easily deals with a large number of semi-continuous variables due to its intrinsic variable selection. For example, the “Addcl 1” random forest dissimilarity weighs the contribution of each variable according to how dependent it is on other variables. The random forest dissimilarity has been used in a variety of applications, e.g. to find clusters of patients based on tissue marker data.

FIG. 12 illustrates one example of a system architecture and data processing device 1200 that may be used to implement one or more illustrative aspects described herein in a standalone and/or networked environment. Various network nodes data server 1210, web server 1206, computer 1204, and laptop 1202 may be interconnected via a wide area network 1208 (WAN), such as the internet. Other networks may also or alternatively be used, including private intranets, corporate networks, LANs, metropolitan area networks (MANs) wireless networks, personal networks (PANs), and the like. Network 1208 is for illustration purposes and may be replaced with fewer or additional computer networks. A local area network (LAN) may have one or more of any known LAN topology and may use one or more of a variety of different protocols, such as ethernet. Devices data server 1210, web server 1206, computer 1204, laptop 1202 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1210, web server 1206, and client computer 1204, laptop 1202. Data server 1210 provides overall access, control and administration of databases and control software for performing one or more illustrative aspects described herein. Data server data server 1210 may be connected to web server 1206 through which users interact with and obtain data as requested. Alternatively, data server 1210 may act as a web server itself and be directly connected to the internet. Data server 1210 may be connected to web server 1206 through the network 1208 (e.g., the internet), via direct or indirect connection, or via some other network. Users may interact with the data server 1210 using remote computer 1204, laptop 1202, e.g., using a web browser to connect to the data server 1210 via one or more externally exposed web sites hosted by web server 1206. Client computer 1204, laptop 1202 may be used in concert with data server 1210 to access data stored therein or may be used for other purposes. For example, from client computer 1204, a user may access web server 1206 using an internet browser, as is known in the art, or by executing a software application that communicates with web server 1206 and/or data server 1210 over a computer network (such as the internet).

Servers and applications may be combined on the same physical machines, and retain separate virtual or logical addresses, or may reside on separate physical machines. FIG. 12 illustrates just one example of a network architecture that may be used, and those of skill in the art will appreciate that the specific network architecture and data processing devices used may vary, and are secondary to the functionality that they provide, as further described herein. For example, services provided by web server 1206 and data server 1210 may be combined on a single server.

Each component data server 1210, web server 1206, computer 1204, laptop 1202 may be any type of known computer, server, or data processing device. Data server 1210, e.g., may include a processor 1212 controlling overall operation of the data server 1210. Data server 1210 may further include RAM 1216, ROM 1218, network interface 1214, input/output interfaces 1220 (e.g., keyboard, mouse, display, printer, etc.), and memory 1222. Input/output interfaces 1220 may include a variety of interface units and drives for reading, writing, displaying, and/or printing data or files. Memory 1222 may further store operating system software 1224 for controlling overall operation of the data server 1210, control logic 1226 for instructing data server 1210 to perform aspects described herein, and other application software 1228 providing secondary, support, and/or other functionality which may or may not be used in conjunction with aspects described herein. The control logic may also be referred to herein as the data server software control logic 1226. Functionality of the data server software may refer to operations or decisions made automatically based on rules coded into the control logic, made manually by a user providing input into the system, and/or a combination of automatic processing based on user input (e.g., queries, data updates, etc.).

Memory 1222 may also store data used in performance of one or more aspects described herein, including a first database 1232 and a second database 1230. In some embodiments, the first database may include the second database (e.g., as a separate table, report, etc.). That is, the information can be stored in a single database, or separated into different logical, virtual, or physical databases, depending on system design. Web server 1206, computer 1204, laptop 1202 may have similar or different architecture as described with respect to data server 1210. Those of skill in the art will appreciate that the functionality of data server 1210 (or web server 1206, computer 1204, laptop 1202) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A method comprising:
collecting toner level data for a print cartridge in a printing device, during a current replacement cycle of the print cartridge, at toner level data intervals, the toner level data comprising a volume percentage of toner in the print cartridge as time series level data points;
collecting print volume data of the printing device, during the current replacement cycle of the print cartridge, at a print volume data interval, the print volume data comprising a number of pages printed during the print volume data interval as time series volume data points;
applying the toner level data and the print volume data as input variables to a predetermined regression learning process,
wherein the predetermined regression learning process includes a regression model and determines a number of predicted days until the print cartridge requires replacement;
wherein the predetermined regression learning process outputs a predicted number of analytical intervals until the print cartridge needs to be replaced,
wherein the predicted number of analytical intervals is the number of predicted days until the print cartridge requires replacement divided by an analytical interval, and
wherein the analytical interval is a discrete interval of time during a life cycle of the print cartridge; and
triggering a replacement process for the print cartridge on condition that the predicted number of analytical intervals satisfies a threshold.

2. The method of claim 1, wherein the regression model includes a decision tree algorithm.

3. The method of claim 2, wherein the decision tree algorithm includes at least one of a classification tree model, a regression tree model, an ensemble learning model, and combinations thereof.

4. The method of claim 1, wherein the threshold is satisfied when the predicted number of analytical intervals equals two or less.

5. The method of claim 1, wherein the print cartridge includes multiple colors, the toner level data and the print volume data are collected for each color of the print cartridge, and the predetermined regression learning process applies the regression model to the toner level data and the print volume data on a color-by-color basis.

6. The method of claim 1, further comprising training the predetermined regression learning process, the training comprising:
collecting toner level training data, print volume training data, and at least one print cartridge replacement interval, each over a training time interval,
wherein the toner level training data comprises the volume % of toner in the print cartridge as the time series level data points, and
wherein the print volume training data comprises the number of pages printed during the print volume data interval as the time series volume data points;
calculating a discrete print cartridge replacement interval by dividing the at least one print cartridge replacement interval by a training analytical interval, wherein the training analytical interval is a discrete training interval of time during at least one life cycle of the print cartridge;
creating a training data set including input features and targets, the training data set including:
the toner level training data;
the print volume training data; and
the discrete print cartridge replacement interval; and
training the regression model using the training data set, wherein the discrete print cartridge replacement interval is at least one input feature as well as at least one target, thereby creating a trained regression model.

7. The method of claim 6, further comprising:
removing the discrete print cartridge replacement interval from the training data set, thereby forming a test data set;
applying the test data set to the trained regression model, thereby producing a predicted discrete print cartridge replacement interval; and
comparing the predicted discrete print cartridge replacement interval to the discrete print cartridge replacement interval, thereby determining an accuracy of the trained regression model.

8. The method of claim 1, wherein the print volume data includes at least three data points during the print volume data interval.

9. The method of claim 1, wherein the toner level data includes at least three data points during the toner level data interval.

10. The method of claim 1, wherein the analytical interval is at least one week.

11. The method of claim 10, wherein prior customer use for a particular customer determines the analytical interval for the print cartridges of the particular customer.

12. A system comprising:
a printing device;
a print server;
a processor; and
a memory storing instructions that, when executed by the processor, configure the system to:
collect toner level data for a print cartridge in the printing device, during a current replacement cycle of the print cartridge, at toner level data intervals, the toner level data comprising a volume percentage of toner in the print cartridge as time series level data points;
collect print volume data of the printing device, during the current replacement cycle of the print cartridge, at a print volume data interval, the print volume data comprising a number of pages printed during the print volume data interval as time series volume data points;
apply the toner level data and the print volume data as input variables to a predetermined regression learning process on the print server,
wherein the predetermined regression learning process includes a regression model and determines a number of predicted days until the print cartridge requires replacement;
wherein the predetermined regression learning process outputs a predicted number of analytical intervals until the print cartridge needs to be replaced,
wherein the predicted number of analytical intervals is the number of predicted days until the print cartridge requires replacement divided by an analytical interval, and
wherein the analytical interval is a discrete interval of time during a life cycle of the print cartridge; and
trigger a replacement process for the print cartridge on condition that the predicted number of analytical intervals satisfies a threshold.

13. The system of claim 12, wherein the regression model is a decision tree algorithm that includes at least one of a classification tree model, a regression tree model, an ensemble learning model, and combinations thereof.

14. The system of claim 12, wherein the threshold is satisfied when the predicted number of analytical intervals equals two or less.

15. The system of claim 12, wherein the print cartridge includes multiple colors, the toner level data and the print volume data are collected for each color of the print cartridge, and the predetermined regression learning process applies the regression model to the toner level data and the print volume data on a color-by-color basis.

16. The system of claim 12, wherein the instructions further configure the system to train the predetermined regression learning process, the training comprising:
collect toner level training data, print volume training data, and at least one print cartridge replacement interval, each over a training time interval,
wherein the toner level training data comprises the volume % of toner in the print cartridge as the time series level data points, and
wherein the print volume training data comprises the number of pages printed during the print volume data interval as the time series volume data points;
calculate a discrete print cartridge replacement interval by dividing the at least one print cartridge replacement interval by a training analytical interval, wherein the training analytical interval is a discrete training interval of time during at least one life cycle of the print cartridge;
create a training data set including input features and targets, the training data set including:
the toner level training data;
the print volume training data; and
the discrete print cartridge replacement interval; and
train the regression model using the training data set, wherein the discrete print cartridge replacement interval is at least one input feature as well as at least one target, thereby creating a trained regression model.

17. The system of claim 16, wherein the instructions further configure the system to:
remove the discrete print cartridge replacement interval from the training data set, thereby forming a test data set;
apply the test data set to the trained regression model, thereby producing a predicted discrete print cartridge replacement interval; and
compare the predicted discrete print cartridge replacement interval to the discrete print cartridge replacement interval, thereby determining an accuracy of the trained regression model.

18. A printing device comprising:
a processor; and
a memory storing instructions that, when executed by the processor, configure the printing device to:
collect toner level data for a print cartridge in the printing device, during a current replacement cycle of the print cartridge, at toner level data intervals, the toner level data comprising a volume percentage of toner in the print cartridge as time series level data points;
collect print volume data of the printing device, during the current replacement cycle of the print cartridge, at a print volume data interval, the print volume data comprising a number of pages printed during the print volume data interval as time series volume data points;
apply the toner level data and the print volume data as input variables to a predetermined regression learning process,
wherein the predetermined regression learning process includes a regression model and determines a number of predicted days until the print cartridge requires replacement;
wherein the predetermined regression learning process outputs a predicted number of analytical intervals until the print cartridge needs to be replaced,
wherein the predicted number of analytical intervals is the number of predicted days until the print cartridge requires replacement divided by an analytical interval, and
wherein the analytical interval is a discrete interval of time during a life cycle of the print cartridge; and
trigger a replacement process for the print cartridge on condition that the predicted number of analytical intervals satisfies a threshold.

19. The printing device of claim 18, wherein the regression model is a decision tree algorithm that includes at least one of a classification tree model, a regression tree model, an ensemble learning model, and combinations thereof.

20. The printing device of claim 18, wherein the print cartridge includes multiple colors, the toner level data and the print volume data are collected for each color of the print cartridge, and the predetermined regression learning process applies the regression model to the toner level data and the print volume data on a color-by-color basis.
